(19) United States
(12) Patent Application Publication
(10) Pub. No.: US 2025/0224597 A1
(43) Pub. Date: Jul. 10, 2025

(54) INFRARED IMAGING LENS

(71) Applicant: Young Optics Inc., Hsinchu Science Park (TW)

(72) Inventors: TSUNG-PEI HSIEH, Hsinchu Science Park (TW); HONG-HSUAN SHIAO, Hsinchu Science Park (TW)

(21) Appl. No.: 18/740,882

(22) Filed: Jun. 12, 2024

(30) Foreign Application Priority Data
Jan. 4, 2024 (TW) 113100382

(51) Int. Cl. G02B 13/00

(52) U.S. Cl. CPC G02B 13/008; G02B 13/004; G02B 13/0045

(57) ABSTRACT

An infrared imaging lens includes a first lens, a second lens, a third lens and a fourth lens with refractive powers arranged in order from an object side to an image side of the infrared imaging lens. The infrared imaging lens satisfies conditions of DFOV≥100°, f≤1.5 and 0.14≤EFL/LT<1.0, where DFOV is a diagonal field of view of the infrared imaging lens, f is an F-number of the infrared imaging lens, EFL is an effective focal length of the infrared imaging lens, and LT is a distance measured along an optical axis between two outermost lens surfaces with refractive powers at opposite ends of the infrared imaging lens.

### CROSS-REFERENCE TO RELATED APPLICATION

This application claims the priority benefit of Taiwan application serial no. 113100382, filed Jan. 4, 2024. The entirety of the above-mentioned patent application is hereby incorporated by reference herein and made a part of this specification.

### BACKGROUND

### Field of the Invention

The invention relates to an imaging lens, and particularly to an imaging lens suitable for infrared imaging applications.

### Description of the Related Art

Infrared imaging lenses are commonly used in vehicles, surveillance, and action cameras. They are often employed as imaging lenses for laser detection/ranging, industrial automation, or 3D depth imaging applications, such as time-of-flight (TOF) lenses used in automated guided vehicles or 3D scanners. With the advancement of autonomous driving, industrial automation, and 3D depth imaging, the quality requirements for automotive lenses and 3D depth imaging lenses are increasingly elevated. Therefore, it is desirable to provide an imaging lens that has a small volume, a wide field of view, reduced stray light and a wide operating temperature range and can provide good infrared imaging quality.

### BRIEF SUMMARY OF THE INVENTION

In order to achieve one or a portion of or all of the objects or other objects, one embodiment of the invention provides an infrared imaging lens including a first lens, a second lens, a third lens and a fourth lens with refractive powers arranged in order from an object side to an image side of the infrared imaging lens. A total number of lenses with refractive powers of the infrared imaging lens is at most seven, and an aperture stop disposed between the first lens and the fourth lens. The infrared imaging lens satisfies conditions of DFOV≥100°, f≤1.5 and 0.14≤EFL/LT<1.0, where DFOV is a diagonal field of view of the infrared imaging lens, f is an F-number of the infrared imaging lens, EFL is an effective focal length of the infrared imaging lens, and LT is a distance measured along an optical axis between two outermost lens surfaces with refractive powers at opposite ends of the infrared imaging lens.

Another embodiment of the invention provides an infrared imaging lens including a first lens, a second lens, a third lens and a fourth lens with refractive powers arranged in order from an object side to an image side of the infrared imaging lens. A total number of lenses with refractive powers of the infrared imaging lens is at most seven, and an aperture stop disposed between the first lens and the fourth lens. The infrared imaging lens satisfies conditions of DFOV≥100°, 0.13≤IMH/LT≤0.18 and 0.14≤EFL/LT<1.0, where DFOV is a diagonal field of view of the infrared imaging lens, IMH is a semi-diagonal image height of the infrared imaging lens, EFL is an effective focal length of the infrared imaging lens, and LT is a distance measured along an optical axis between two outermost lens surfaces with refractive powers at opposite ends of the infrared imaging lens.

Through the design of various embodiments of the invention, an infrared imaging lens can be provided with at least one of the advantages of wide viewing angles, large effective apertures, reduced stray light, low thermal drift, wide working temperature ranges, and high-resolution imaging qualities.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

FIG. 1 shows a schematic diagram of an infrared imaging lens according to a first embodiment of the invention.

FIG. 2A, FIG. 2B and FIG. 2C respectively show longitudinal spherical aberration, field curvature and distortion aberration curves of the infrared imaging lens of FIG. 1 measured at wavelengths of 960 nm, 940 nm and 920 nm.

FIG. 3 shows a schematic diagram of an infrared imaging lens according to a second embodiment of the invention.

FIG. 4A, FIG. 4B and FIG. 4C respectively show longitudinal spherical aberration, field curvature and distortion aberration curves of the infrared imaging lens of FIG. 3 measured at wavelengths of 960 nm, 940 nm and 920 nm.

FIG. 5 shows a schematic diagram of an infrared imaging lens according to a third embodiment of the invention.

FIG. 6A, FIG. 6B and FIG. 6C respectively show longitudinal spherical aberration, field curvature and distortion aberration curves of the infrared imaging lens of FIG. 5 measured at wavelengths of 960 nm, 940 nm and 920 nm.

FIG. 7 shows a schematic diagram of an infrared imaging lens according to a fourth embodiment of the invention.

FIG. 8A, FIG. 8B and FIG. 8C respectively show longitudinal spherical aberration, field curvature and distortion aberration curves of the infrared imaging lens of FIG. 7 measured at wavelengths of 960 nm, 940 nm and 920 nm.

FIG. 9 shows a schematic diagram of an infrared imaging lens according to a fifth embodiment of the invention.

FIG. 10A, FIG. 10B and FIG. 10C respectively show longitudinal spherical aberration, field curvature and distortion aberration curves of the infrared imaging lens of FIG. 9 measured at wavelengths of 960 nm, 940 nm and 920 nm.

### DETAILED DESCRIPTION OF THE INVENTION

In the following detailed description of the preferred embodiments, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. Further, “First,” “Second,” etc., as used herein, are used as labels for nouns that they precede, and do not imply any type of ordering (e.g., spatial, temporal, logical, etc.).

The term “lens” refers to an element made from a partially or entirely light-transmissive material with optical power. The material commonly includes plastic or glass.

In an imaging system, an object side may refer to one side of an optical path of an imaging lens comparatively near a subject to be picked-up, and an image side may refer to other side of the optical path comparatively near a photosensor.

A certain region of an object side surface (or an image side surface) of a lens may be convex or concave. Herein, a convex or concave region is more outwardly convex or inwardly concave in the direction of an optical axis as compared with other neighboring regions of the object/image side surface.

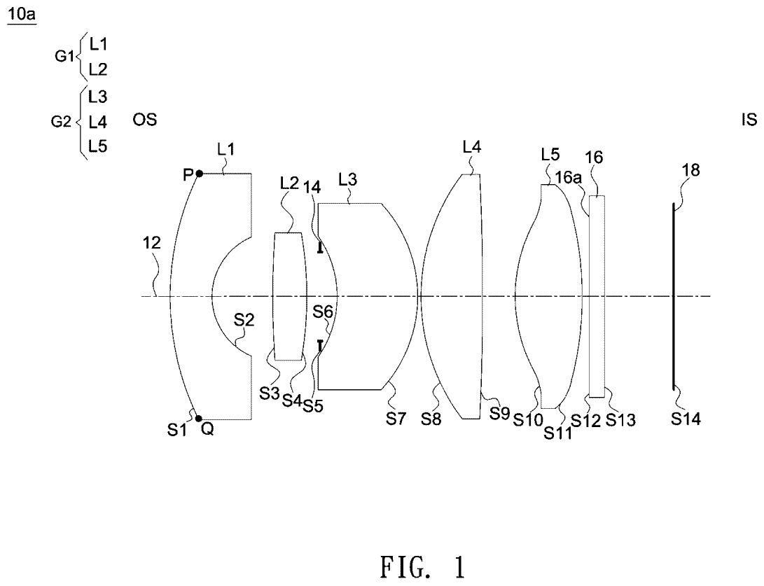

FIG. 1 shows a schematic diagram of an infrared imaging lens according to a first embodiment of the invention. Referring to FIG. 1, the infrared imaging lens 10a includes, in order from an object side OS to an image side IS of the infrared imaging lens 10a, a lens L1, a lens L2, a lens L3, a lens L4 and a lens L5 with refractive powers, where the lens L1 and the lens L2 constitute a lens group G1 and the lens L3, the lens L4 and the lens L5 constitute a lens group G2. Furthermore, a cover plate 16 and an image sensor (not shown) can be arranged on the image side IS. The cover plate 16 may be a plate made of any suitable light-transmissive material, such as glass. The cover plate 16 may function to adjust the optical path length and protect the infrared imaging lens. An image plane (infrared focal plane) of the infrared imaging lens 10a on the image sensor is marked as 18. Moreover, in one embodiment, the cover plate 16 includes an optical filter, such as a filter film 16a, to block light outside a wavelength band of 920-960 nm. In other embodiment, an independent optical filter can be used instead and arranged on one side of the lens L5 away from the object side OS. The aperture stop 14 is a light-blocking element that limits the amount of light passing through the infrared imaging lens. In other embodiment, the aperture stop 14 is defined by an inner diameter of a lens barrel and thus is not an independent optical element. Light from a subject to be captured may enter the infrared imaging lens 10a and pass through the lens L1, the lens L2, the aperture stop 14, the lens L3, the lens L4, the lens L5 and the cover plate 16 in succession, and finally forms an image on the image plane 18.

In each of the following embodiments, the object side OS is located on the left side and the image side IS is located on the right side of each figure, and thus this is not repeatedly described in the following for brevity. In this embodiment, the lenses L1-L5 of the infrared imaging lens 10a respectively have object-side surfaces S1, S3, S6, S8 and S10 facing the object side OS and allowing light beams to pass therethrough, and the lenses L1-L5 respectively have image-side surfaces S2, S4, S7, S9, S10 and S11 facing the image side IS and allowing light beams to pass therethrough, and refractive powers of the lenses L1-L5 are negative, positive, positive, positive and positive, respectively. In this embodiment, the lens L1, the lens L2, the lens L3 and the lens L4 are glass spherical lens, the lens L5 is a glass-molded aspheric lens, but the invention is not limited thereto.

In at least some embodiments of the invention, within a specific wavelength band of infrared light, the infrared imaging lens may achieve an imaging performance with a modulation transfer function (MTF) greater than 50% at a spatial frequency of 60 lp/mm. Furthermore, in at least some embodiments of the invention, under conditions where a diagonal field of view is 90 degrees and a relative illumination (RI) is greater than 90%, in case a light beam that includes the specific wavelength band of infrared light passes through the infrared imaging lens, a distance between a focal plane of visible light and a focal plane of infrared light on the optical axis of the infrared imaging lens exceeds 5 μm. The aforementioned specific wavelength band of infrared light may be, for example, near-infrared light ranging from 920 to 960 nm.

In at least some embodiments of the invention, a total number of lenses with refractive powers in the infrared imaging lens is at most seven, but the number, shape, and optical properties of the lenses can be designed differently according to actual needs and are not limited to any specific configuration. In at least some embodiments of the invention, an F-number of the infrared imaging lens can be less than or equal to 1.5, and a total track length TTL (for example, a distance from the object-side surface S1 of the lens L1 to the image plane 18 along the optical axis 12 shown in FIG. 1) may range from 18 to 20 mm.

In at least some embodiments of the invention, the infrared imaging lens may satisfy a condition of 0.14≤EFL/LT<1.0, more preferably 0.14≤EFL/LT<0.2, where EFL is an effective focal length of the infrared imaging lens, and LT is a total lens length that is a distance measured along the optical axis 12 between two outermost lens surfaces with refractive powers at opposite ends of the infrared imaging lens (such as the surface S1 and the surface S11 shown in FIG. 1). Meeting the above condition may achieve a balance between miniaturization and optical performance and allow the infrared imaging lens to maintain an optimized ratio between the photosensor's size to the total lens length LT.

In at least some embodiments of the invention, the infrared imaging lens may satisfy a condition of 0.13≤IMH/LT≤0.18, more preferably 0.14≤IMH/LT≤0.16, where IMH is a semi-diagonal image height, and LT is the distance measured along the optical axis 12 between two outermost lens surfaces with refractive powers at opposite ends of the infrared imaging lens (such as the surface S1 and the surface S11 shown in FIG. 1). When the value of IMH/LT is confined within the above range, it facilitates better design parameters for both the total lens length LT and the semi-diagonal image height IMH. Specifically, if the value of IMH/LT falls below the lower limit of the condition, it may result in either an overly large total lens length LT to be unfavorable for a compact design or result in an overly small semi-diagonal image height IMH to complicate the manufacturing and assembly processes. Conversely, exceeding the upper limit of the range may result in a too small lens total length LT that makes the system overly sensitive and complicates tolerance design, or result in an excessively large semi-diagonal image height IMH to obstruct the goal of miniaturization.

Each lens may be assigned a parameter of “outside diameter”. For example, as shown in FIG. 1, the lens L1 has an object-side surface S1 and an image-side surface S2, each lens surface defines two outermost edge turning points P and Q at opposite ends of the optical axis 12, and a maximum distance between the two edge turning points P and Q in the direction perpendicular to the optical axis 12 is referred to as an outside diameter of a lens. In at least some embodiments of the invention, the infrared imaging lens may satisfy conditions of 0.4≤D1/LT<0.8 and 0.3≤DL/LT<0.6, where D1 is an outside diameter of the lens (such as the lens L1) closest to the object side OS, DL is an outside diameter of the lens (such as the lens L5) closest to the image side IS, and LT is the distance measured along the optical axis 12 between two outermost lens surfaces with refractive powers at opposite ends of the infrared imaging lens (such as the surface S1 and the surface S11 shown in FIG. 1). Meeting the condition of 0.4≤D1/LT<0.8 may facilitate light converging capability of lenses to allow for better optical performance in a limited space. Besides, meeting the condition of 0.3≤DL/LT<0.6 is favorable for effectively gathering light to obtain better optical performance in a limited space.

A diagonal field of view (DFOV) refers to a light collection angle of the optical surface closest to the object side; that is, the DFOV is a full field of view measured diagonally. In at least some embodiments, the DFOV of the infrared imaging lens is greater than or equal to 100 degrees, and more preferably ranging from 100 to 130 degrees. In this embodiment, the DFOV of the infrared imaging lens 10a is 114.5 degrees.

In this embodiment, the infrared imaging lens 10a includes five lenses with refractive powers. In this embodiment of the infrared imaging lens 10a, an effective focal length EFL is 2.3 mm, an F-number (F #) is 1.1, a total lens length is 14.28 mm, a total track length TTL is 18.0 mm, a semi-diagonal image height IMH is 2.25 mm, an outside diameter D1 of the lens closest to the object side OS is 8.3 mm, an outside diameter DL of the lens closest to the image side IS is 7.3 mm, EFL/LT=0.16, IMH/LT=0.15, D1/LT=0.57 and DL/LT=0.50.

Detailed optical data and design parameters of the infrared imaging lens 10a are shown in Table 1 below. Note the data provided below are not used for limiting the invention, and those skilled in the art may suitably modify parameters or settings of the following embodiment with reference of the invention without departing from the scope or spirit of the invention.

Table 1 lists the values of parameters for each lens of an infrared imaging system. Besides, the radius of curvature and interval shown in Table 1 are all in a unit of mm. The field heading “radius of curvature” shown in Table 1 is a reciprocal of the curvature. When a lens surface has a positive radius of curvature, the center of the lens surface is located towards the image side. When a lens surface has a negative radius of curvature, the center of the lens surface is located towards the object side. The field heading “interval” represents a distance between two adjacent surfaces along the optical axis 12 of the infrared imaging lens 10a. For example, an interval of the surface S1 is a distance between the surface S1 and the surface S2 along the optical axis 12, an interval of the surface S2 is a distance between the surface S2 and the surface S3 along the optical axis 12. Further, the interval, refractive index and Abbe number of any lens listed in the column of “Object description” show values in a horizontal row aligned with the position of that lens, so that related descriptions are omitted for sake of brevity.

TABLE 1

| Object | | Radius of | Interval | Refractive | Abbe |
|---|---|---|---|---|---|
| description | Surface | curvature(mm) | (mm) | Index (nd) | number (Vd) |
| lens L1(meniscus) | S1 | 12.044 | 1.508 | 1.804 | 47 |
| | S2 | 2.680 | 2.207 | | |
| lens L2(bi-convex) | S3 | 169.225 | 1.134 | 1.946 | 18 |
| | S4 | −14.507 | 0.626 | | |
| aperture stop 14 | S5 | Infinity | 0.515 | | |
| lens L3(meniscus) | S6 | −4.270 | 2.862 | 1.904 | 31 |
| | S7 | −5.413 | 0.100 | | |
| lens L4(bi-convex) | S8 | 8.430 | 2.175 | 1.904 | 31 |
| | S9 | −93.179 | 1.174 | | |
| lens L5(aspheric) | S10* | 5.621 | 2.400 | 1.495 | 81 |
| | S11* | −10.166 | 0.300 | | |
| cover plate 16 | S12 | Infinity | 0.500 | 1.517 | 64 |
| | S13 | Infinity | 2.500 | | |
| image plane 18 | S14 | Infinity | 0 | | |

An aspheric lens indicates at least one of its front lens surface and rear lens surface has a radius of curvature that varies along a center axis to correct abbreviations. In the following design examples of the invention, each aspheric surface satisfies the following equation:

$$Z = \frac{c {r}^{2}}{1 + \sqrt{1 - ( 1 + k ) {c}^{2} {r}^{2}}} + A {r}^{4} + B {r}^{6} + C {r}^{8} + D {r}^{10} + {Er}^{12} + F {r}^{14} + {Gr}^{16} + … ,$$

where Z denotes a sag of an aspheric surface along the optical axis 12, c denotes a reciprocal of a radius of an osculating sphere, K denotes a conic constant, r denotes a height of the aspheric surface measured in a direction perpendicular to the optical axis 12, and parameters A-G are 4th, 6th, 8th, 10th, 12th, 14th and 16th order aspheric coefficients. Note the data provided below are not used for limiting the invention, and those skilled in the art may suitably modify parameters or settings of the following embodiment with reference of the invention without departing from the scope or spirit of the invention.

Table 2 shows the conic constant and aspheric coefficients for each aspheric surface of the infrared imaging lens 10a.

TABLE 2

| Surface | S10* | S11* |
|---|---|---|
| K | −1.706 | −57.731 |
| A | −3.40E−06 | −2.13E−03 |
| B | −5.81E−05 | 4.22E−04 |
| C | 5.36E−06 | −4.06E−05 |
| D | −6.08E−07 | 1.72E−06 |
| E | 8.91E−09 | −3.36E−08 |

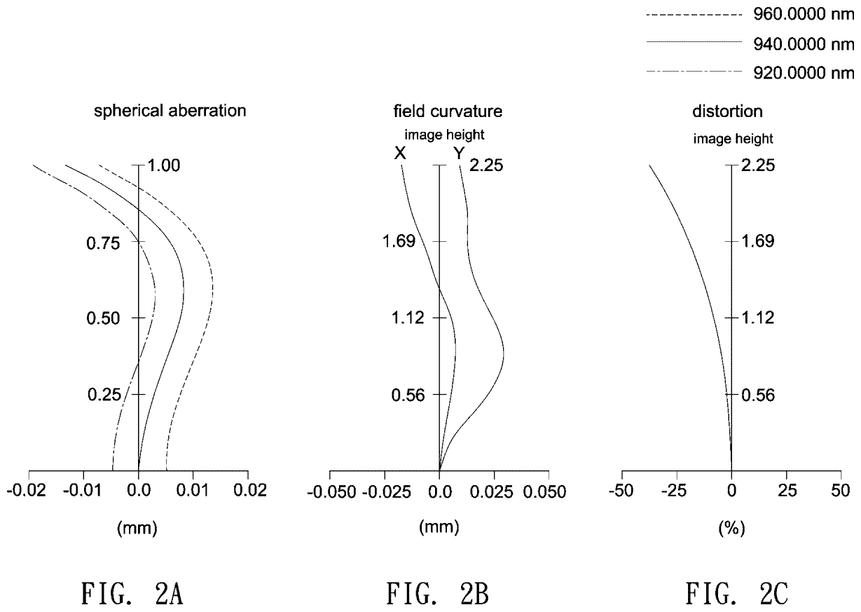

FIG. 2A, FIG. 2B and FIG. 2C respectively show longitudinal spherical aberration, field curvature and distortion aberration curves of the infrared imaging lens 10a measured at wavelengths of 960 nm, 940 nm and 920 nm. Because the graphs shown in FIG. 2A, FIG. 2B and FIG. 2C are all within the standard range, it can be verified that the infrared imaging lens 10a can achieve high-resolution infrared imaging effects.

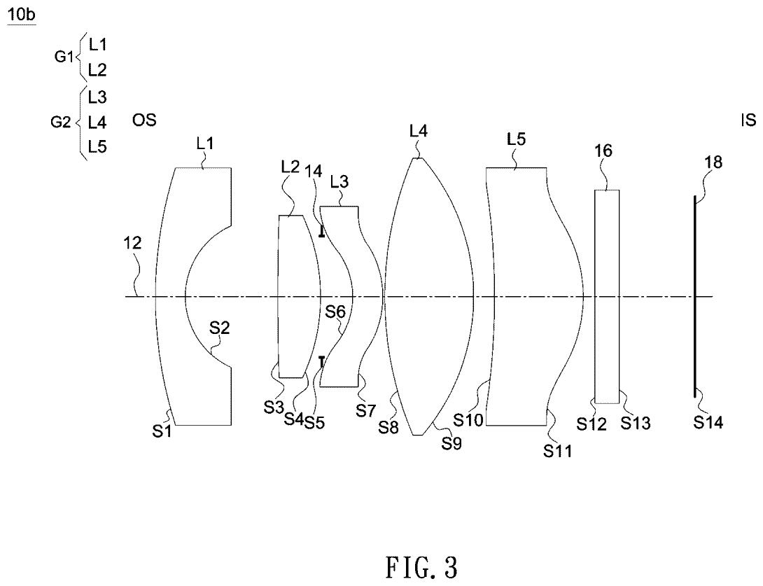

FIG. 3 shows a schematic diagram of an infrared imaging lens according to a second embodiment of the invention. In this embodiment, the infrared imaging lens 10b includes a lens L1, a lens L2, a lens L3, a lens L4 and a lens L5 with refractive powers arranged in order from the object side OS to the image side IS and includes an aperture stop 14 disposed between the lens L2 and the lens L3. The refractive powers of the lenses L1-L5 are negative, positive, negative, positive and positive, respectively. In this embodiment, the lens L1, the lens L2 and the lens L4 are glass spherical lenses, and the lens L3 and the lens L5 are glass-molded aspheric lenses, but the invention is not limited thereto.

In this embodiment, the infrared imaging lens 10b includes five lenses with refractive powers. In this embodiment of the infrared imaging lens 10b, an effective focal length EFL is 2.3 mm, an F-number (F #) is 1.1, a diagonal field of view DFOV is 115.0 degrees, a total lens length LT is 14.28 mm, a total track length TTL is 18.0 mm, a semi-diagonal image height IMH is 2.25 mm, an outside diameter D1 of the lens closest to the object side OS is 8.0 mm, an outside diameter DL of the lens closest to the image side IS is 7.5 mm, EFL/LT=0.16, IMH/LT=0.16, D1/LT=0.56 and DL/LT=0.53.

Detailed optical data and design parameters of the lenses and other optical components of the infrared imaging lens 10b are shown in Table 3.

TABLE 3

| Object | | Radius of | Interval | Refractive | Abbe |
|---|---|---|---|---|---|
| description | Surface | curvature(mm) | (mm) | Index (nd) | number (Vd) |
| lens L1(meniscus) | S1 | 16.087 | 1.000 | 1.904 | 31 |
| | S2 | 2.813 | 3.128 | | |
| lens L2(bi-convex) | S3 | 267.835 | 1.394 | 1.904 | 31 |
| | S4 | −7.710 | 0.100 | | |
| aperture stop 14 | S5 | Infinity | 0.960 | | |
| lens L3(aspheric) | S6* | −2.256 | 1.000 | 1.81 | 41 |
| | S7* | −2.925 | 0.100 | | |
| lens L4(bi-convex) | S8 | 13.347 | 2.918 | 1.835 | 43 |
| | S9 | −8.047 | 0.665 | | |
| lens L5(aspheric) | S10* | −40.652 | 3.010 | 1.497 | 82 |
| | S11* | −4.606 | 0.350 | | |
| cover plate 16 | S12 | Infinity | 0.800 | 1.517 | 64 |
| | S13 | Infinity | 2.574 | | |
| image plane 18 | S14 | Infinity | 0 | | |

Table 4 shows the conic constant and aspheric coefficients for each aspheric surface of the infrared imaging lens 10b.

TABLE 4

| Surface | S6* | S7* | S10* | S11* |
|---|---|---|---|---|
| K | −2.094 | −3.888 | 88.603 | −2.188 |
| A | −5.88E−03 | −9.66E−03 | 9.03E−04 | 4.29E−04 |
| B | 2.35E−03 | 2.60E−03 | −3.09E−04 | −2.52E−04 |
| C | −1.64E−04 | −2.59E−04 | 1.98E−05 | 3.19E−05 |
| D | 4.11E−06 | 2.16E−05 | 1.80E−08 | −1.75E−06 |
| E | −2.26E−08 | −8.61E−07 | −1.38E−08 | 5.30E−08 |

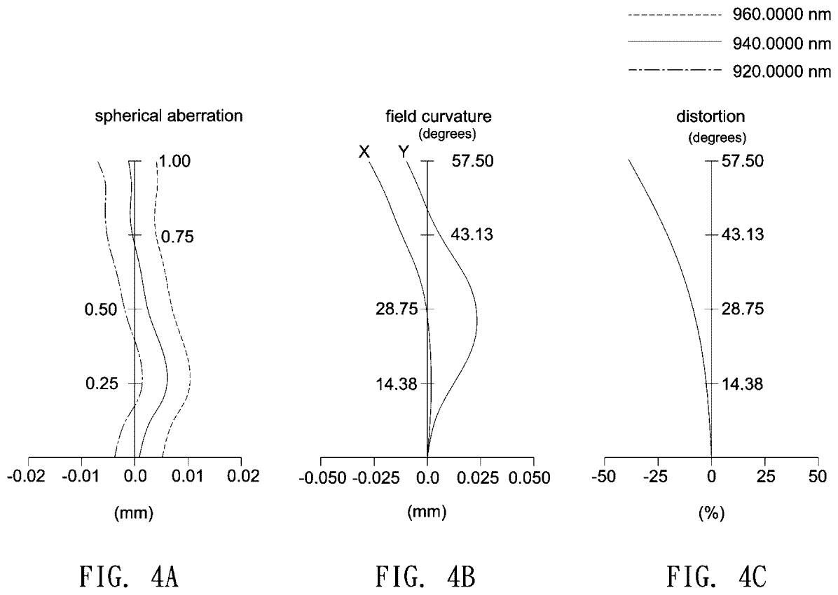

FIG. 4A, FIG. 4B and FIG. 4C respectively show longitudinal spherical aberration, field curvature and distortion aberration curves of the infrared imaging lens 10b measured at wavelengths of 960 nm, 940 nm and 920 nm. Because the graphs shown in FIG. 4A, FIG. 4B and FIG. 4C are all within the standard range, it can be verified that the infrared imaging lens 10b can achieve high-resolution infrared imaging effects.

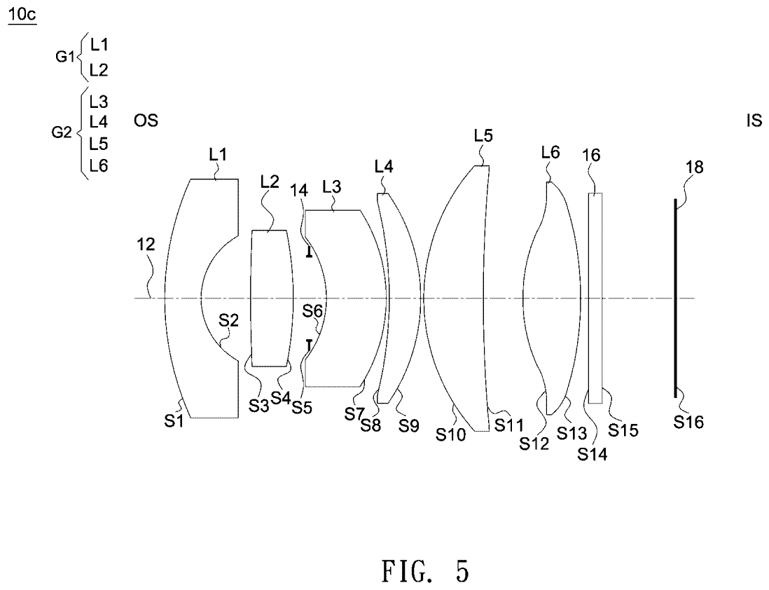

FIG. 5 shows a schematic diagram of an infrared imaging lens according to a third embodiment of the invention. In this embodiment, the infrared imaging lens c includes a lens L1, a lens L2, a lens L3, a lens L4, a lens L5 and a lens L6 with refractive powers arranged in order from the object side OS to the image side IS and includes an aperture stop 14 disposed between the lens L2 and the lens L. The refractive powers of the lenses L1-L6 are negative, positive, positive, positive, positive and positive, respectively. In this embodiment, the lens L1, the lens L2, the lens L3, the lens L4 and the lens L5 are glass spherical lenses, and the lens L6 is a glass-molded aspheric lens, but the invention is not limited thereto.

In this embodiment, the infrared imaging lens 10c includes six lenses with refractive powers. In this embodiment of the infrared imaging lens 10c, an effective focal length EFL is 2.3 mm, an F-number (F #) is 1.1, a diagonal field of view DFOV is 116.2 degrees, a total lens length LT is 14.73 mm, a total track length TTL is 18.1 mm, a semi-diagonal image height IMH is 2.25 mm, an outside diameter D1 of the lens closest to the object side OS is 8.4 mm, an outside diameter DL of the lens closest to the image side IS is 7.4 mm, EFL/LT=0.16, IMH/LT=0.15, D1/LT=0.57 and DL/LT=0.50.

TABLE 5

| Object | | Radius of | Interval | Refractive | Abbe |
|---|---|---|---|---|---|
| description | Surface | curvature(mm) | (mm) | index (nd) | number (Vd) |
| lens L1(meniscus) | S1 | 11.905 | 1.237 | 1.804 | 47 |
| | S2 | 2.734 | 1.835 | | |
| lens L2(bi-convex) | S3 | 53.418 | 1.447 | 1.946 | 18 |
| | S4 | −24.079 | 0.695 | | |
| aperture stop 14 | S5 | Infinity | 0.532 | | |
| lens L3(meniscus) | S6 | −3.979 | 2.133 | 1.904 | 31 |
| | S7 | −6.513 | 0.100 | | |
| lens L4(meniscus) | S8 | −15.776 | 1.105 | 1.904 | 31 |
| | S9 | −7.327 | 0.100 | | |
| lens L5(meniscus) | S10 | 8.066 | 2.175 | 1.904 | 31 |
| | S11 | 84.033 | 1.338 | | |
| lens L6(aspheric) | S12* | 5.920 | 2.034 | 1.495 | 81 |
| | S13* | −10.312 | 0.299 | | |
| cover plate 16 | S14 | Infinity | 0.500 | 1.517 | 64 |
| | S15 | Infinity | 2.568 | | |
| image plane 18 | S16 | Infinity | 0 | | |

Table 6 shows the conic constant and aspheric coefficients for each aspheric surface of the infrared imaging lens 10c.

TABLE 6

| Surface | S12* | S13* |
|---|---|---|
| K | −1.804 | −51.741 |
| A | −3.40E−06 | −2.13E−03 |
| B | −5.81E−05 | 4.22E−04 |
| C | 5.36E−06 | −4.06E−05 |
| D | −6.08E−07 | 1.72E−06 |
| E | 8.91E−09 | −3.36E−08 |

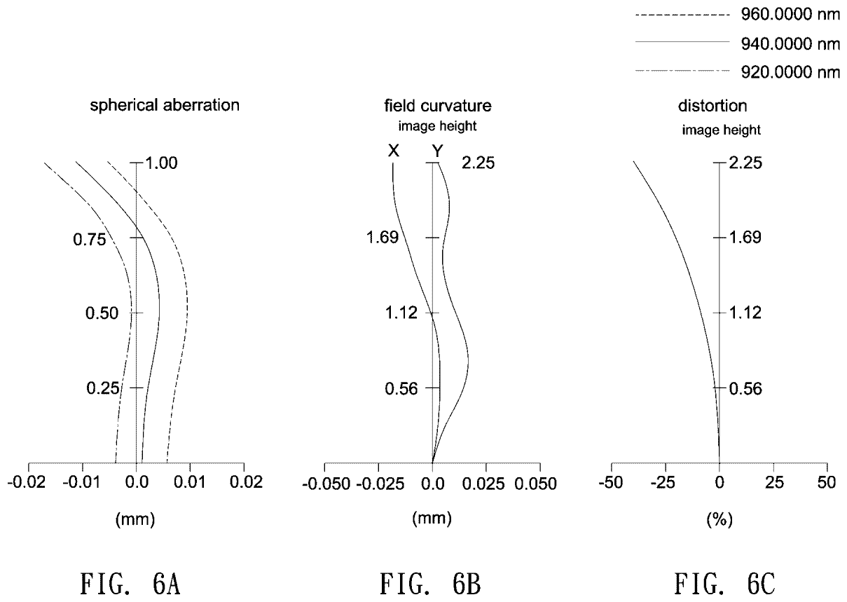

FIG. 6A, FIG. 6B and FIG. 6C respectively show longitudinal spherical aberration, field curvature and distortion aberration curves of the infrared imaging lens 10c measured at wavelengths of 960 nm, 940 nm and 920 nm. Because the graphs shown in FIG. 6A, FIG. 6B and FIG. 6C are all within the standard range, it can be verified that the infrared imaging lens 10c can achieve high-resolution infrared imaging effects.

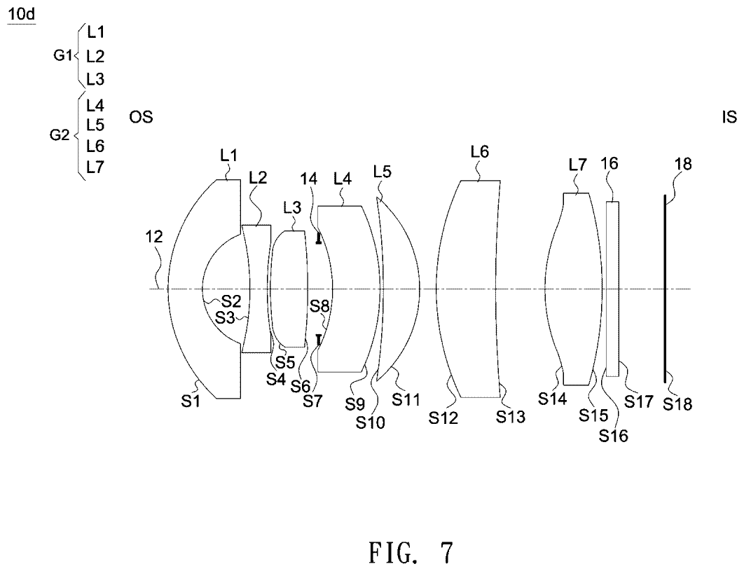

FIG. 7 shows a schematic diagram of an infrared imaging lens according to a fourth embodiment of the invention. In this embodiment, the infrared imaging lens 10d includes a lens L1, a lens L2, a lens L3, a lens L4, a lens L5, a lens L6 and a lens L7 with refractive powers arranged in order from the object side OS to the image side IS and includes an aperture stop 14 disposed between the lens L3 and the lens L4. The refractive powers of the lenses L1-L7 are negative, negative, positive, positive, positive, positive and positive, respectively. In this embodiment, the lens L1, the lens L4, the lens L5 and the lens L6 are glass spherical lenses, and the lens L2, the lens L3 and the lens L7 are glass-molded aspheric lenses, but the invention is not limited thereto.

In this embodiment, the infrared imaging lens 10d includes seven lenses with refractive powers. In this embodiment of the infrared imaging lens d, an effective focal length EFL is 2.2 mm, an F-number (F #) is 1.1, a diagonal field of view DFOV is 117 degrees, a total lens length LT is 15.85 mm, a total track length TTL is 18.1 mm, a semi-diagonal image height IMH is 2.25 mm, an outside diameter D1 of the lens closest to the object side OS is 7.4 mm, an outside diameter DL of the lens closest to the image side IS is 6.1 mm, EFL/LT=0.14, IMH/LT=0.14, D1/LT=0.47 and DL/LT=0.39.

Detailed optical data and design parameters of the lenses and other optical components of the infrared imaging lens 10d are shown in Table 7.

TABLE 7

| Object | | Radius of | Interval | Refractive | Abbe |
|---|---|---|---|---|---|
| description | Surface | curvature(mm) | (mm) | index (nd) | number (Vd) |
| lens L1(meniscus) | S1 | 6.193 | 1.230 | 1.804 | 47 |
| | S2 | 2.286 | 1.772 | | |
| lens L2(aspheric) | S3* | −6.275 | 0.629 | 1.946 | 18 |
| | S4* | 38.089 | 0.100 | | |
| lens L3(aspheric) | S5* | 15.207 | 1.371 | 1.946 | 18 |
| | S6* | −12.148 | 0.480 | | |
| aperture stop 14 | S7 | Infinity | 0.440 | | |
| lens L4(meniscus) | S8 | −5.626 | 1.708 | 1.904 | 31 |
| | S9 | −8.411 | 0.100 | | |
| lens L5(meniscus) | S10 | −29.937 | 1.313 | 1.904 | 31 |
| | S11 | −5.074 | 0.647 | | |
| lens L6(meniscus) | S12 | 10.567 | 2.175 | 1.904 | 31 |
| | S13 | 74.375 | 1.798 | | |
| lens L7(aspheric) | S14* | 6.620 | 2.087 | 1.497 | 82 |
| | S15* | −12.012 | 0.100 | | |
| cover plate 16 | S16 | Infinity | 0.500 | 1.517 | 64 |
| | S17 | Infinity | 1.650 | | |
| image plane 18 | S18 | Infinity | 0 | | |

Table 8 shows the conic constant and aspheric coefficients for each aspheric surface of the infrared imaging lens 10d.

TABLE 8

| Surface | S3* | S4* | S5* | S6* | S14* | S15* |
|---|---|---|---|---|---|---|
| K | −15.463 | 99.000 | −99.000 | −26.891 | −2.741 | −65.302 |
| A | −3.71E−04 | 1.83E−03 | 3.88E−04 | 1.98E−03 | −3.40E−06 | −2.13E−03 |
| B | −2.03E−05 | 3.71E−04 | 5.81E−04 | 6.36E−04 | −5.81E−05 | 4.22E−04 |
| C | 5.26E−05 | 9.17E−05 | 2.18E−04 | −8.10E−05 | 5.36E−06 | −4.06E−05 |
| D | −3.62E−06 | 8.14E−05 | 3.37E−05 | 2.31E−05 | −6.08E−07 | 1.72E−06 |
| E | 0 | 0 | 0 | 0 | 8.91E−09 | −3.36E−08 |

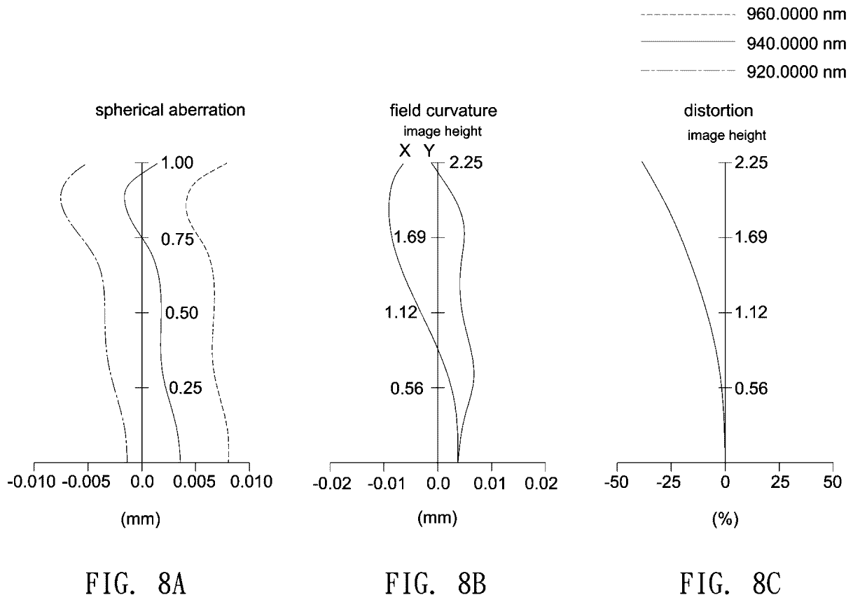

FIG. 8A, FIG. 8B and FIG. 8C respectively show longitudinal spherical aberration, field curvature and distortion aberration curves of the infrared imaging lens 10d measured at wavelengths of 960 nm, 940 nm and 920 nm. Because the graphs shown in FIG. 8A, FIG. 8B and FIG. 8C are all within the standard range, it can be verified that the infrared imaging lens 10d can achieve high-resolution infrared imaging effects.

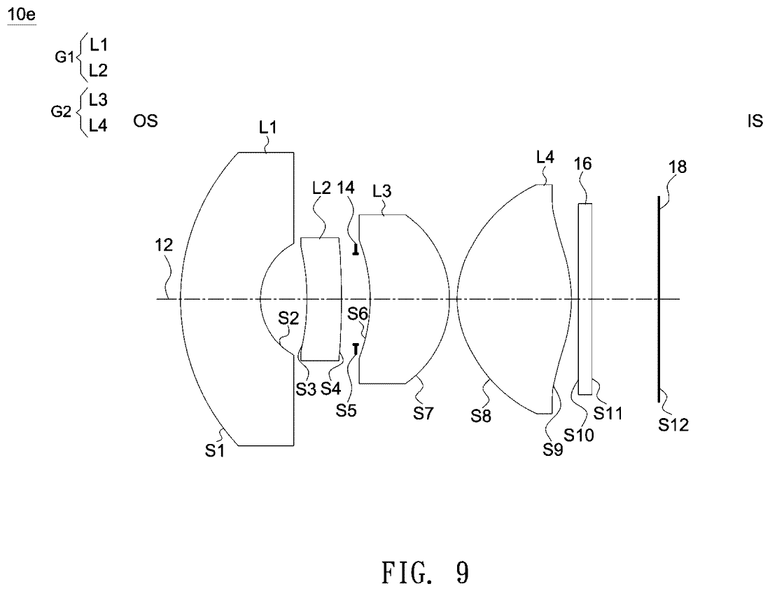

FIG. 9 shows a schematic diagram of an infrared imaging lens according to a fifth embodiment of the invention. In this embodiment, the infrared imaging lens 10e includes a lens L1, a lens L2, a lens L3 and a lens L4 with refractive powers arranged in order from the object side OS to the image side IS and includes an aperture stop 14 disposed between the lens L2 and the lens L3. The refractive powers of the lenses L1-L4 are positive, negative, positive and positive, respectively. In this embodiment, the lens L1 and the lens L3 are glass spherical lenses, and the lens L2 and the lens L4 are glass-molded aspheric lenses, but the invention is not limited thereto.

In this embodiment, the infrared imaging lens 10e includes four lenses with refractive powers. In this embodiment of the infrared imaging lens 10e, an effective focal length EFL is 2.5 mm, an F-number (F #) is 1.1, a diagonal field of view DFOV is 118.4 degrees, a total lens length LT is 14.65 mm, a total track length TTL is 17.9 mm, a semi-diagonal image height IMH is 2.25 mm, an outside diameter D1 of the lens closest to the object side OS is 10.4 mm, an outside diameter DL of the lens closest to the image side IS is 7.4 mm, EFL/LT=0.17, IMH/LT=0.15, D1/LT=0.71 and DL/LT=0.51.

Detailed optical data and design parameters of the lenses and other optical components of the infrared imaging lens 10e are shown in Table 9.

TABLE 9

| Object | | Radius of | Interval | Refractive | Abbe |
|---|---|---|---|---|---|
| description | Surface | curvature(mm) | (mm) | index (nd) | number (Vd) |
| lens L1(meniscus) | S1 | 9.143 | 2.977 | 1.804 | 47 |
| | S2 | 2.560 | 1.759 | | |
| lens L2(aspheric) | S3* | −14.170 | 1.263 | 1.946 | 18 |
| | S4* | −22.560 | 0.643 | | |
| aperture stop 14 | S5 | Infinity | 0.463 | | |
| lens L3(meniscus) | S6 | −7.891 | 2.999 | 1.904 | 31 |
| | S7 | −4.374 | 0.258 | | |
| lens LA(aspheric) | S8* | 4.258 | 4.291 | 1.495 | 81 |
| | S9* | −6.083 | 0.265 | | |
| cover plate 16 | S10 | Infinity | 0.500 | 1.517 | 64 |
| | S11 | Infinity | 2.500 | | |
| image plane 18 | S12 | Infinity | 0 | | |

Table 10 shows the conic constant and aspheric coefficients for each aspheric surface of the infrared imaging lens 10e.

TABLE 10

| Surface | S3* | S4* | S8* | S9* |
|---|---|---|---|---|
| K | 20.857 | 60.764 | −1.163 | −13.300 |
| A | −3.57E−03 | 4.00E−04 | 3.13E−04 | −3.08E−03 |
| B | −3.35E−04 | 3.97E−04 | −8.95E−06 | 4.81E−04 |
| C | 6.40E−05 | −2.08E−05 | 6.04E−06 | −3.84E−05 |
| D | −7.43E−06 | 1.83E−05 | −5.14E−07 | 1.59E−06 |
| E | 0 | 0 | 1.69E−08 | −1.92E−08 |

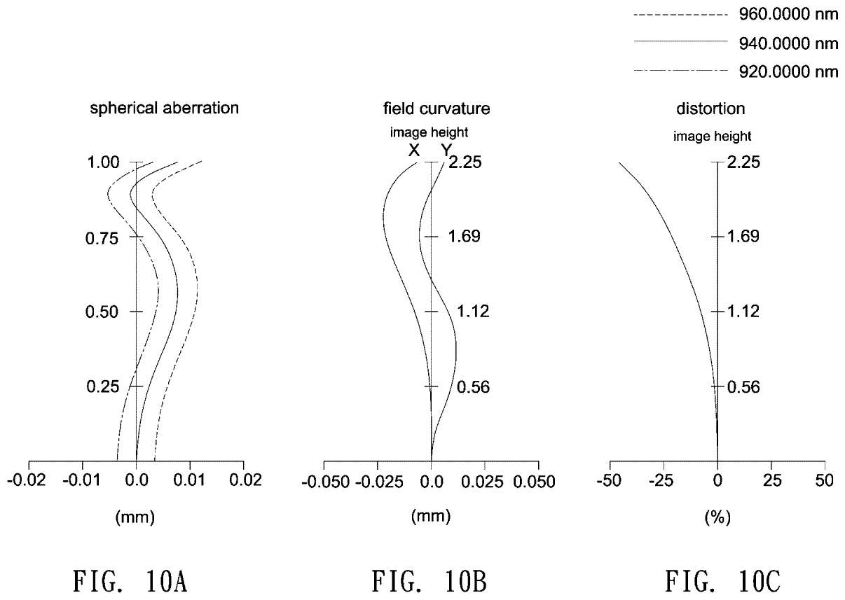

FIG. 10A, FIG. 10B and FIG. 10C respectively show longitudinal spherical aberration, field curvature and distortion aberration curves of the infrared imaging lens 10e measured at wavelengths of 960 nm, 940 nm and 920 nm. Because the graphs shown in FIG. 10A, FIG. 10B and FIG. 10C are all within the standard range, it can be verified that the infrared imaging lens 10e can achieve high-resolution infrared imaging effects.

According to the above embodiments, meeting the designed characteristics and arrangement of optical components set forth in the above may achieve good infrared imaging qualities, reduced stray light and a short total lens length, under the condition of a wide field of view and large aperture. Further, according to the above embodiments, an all-glass lens design can be adopted to obtain higher light transmittance, greater hardness, and enhanced wear resistance. Additionally, due to the relatively low thermal expansion coefficient of glass lenses, it can prevent thermal drift in infrared imaging lenses, thereby providing a broader operating temperature range and thus ensuring stable image quality in environments with large temperature differences. Therefore, through the design of various embodiments of the invention, an infrared imaging lens can be provided with at least one of the advantages of wide viewing angles, large effective apertures, reduced stray light, low thermal drift, wide working temperature ranges, and high-resolution imaging qualities.

Though the embodiments of the invention have been presented for purposes of illustration and description, they are not intended to be exhaustive or to limit the invention. Accordingly, many modifications and variations without departing from the spirit of the invention or essential characteristics thereof will be apparent to practitioners skilled in this art. It is intended that the scope of the invention be defined by the claims appended hereto and their equivalents in which all terms are meant in their broadest reasonable sense unless otherwise indicated.

What is claimed is:

1. An infrared imaging lens, comprising:
a first lens, a second lens, a third lens and a fourth lens with refractive powers arranged in order from an object side to an image side of the infrared imaging lens, and a total number of lenses with refractive powers of the infrared imaging lens being at most seven; and
an aperture stop disposed between the first lens and the fourth lens,
wherein the infrared imaging lens satisfies conditions of DFOV≥100°, f≤1.5 and 0.14≤EFL/LT<1.0, where DFOV is a diagonal field of view of the infrared imaging lens, f is an F-number of the infrared imaging lens, EFL is an effective focal length of the infrared imaging lens, and LT is a distance measured along an optical axis between two outermost lens surfaces with refractive powers at opposite ends of the infrared imaging lens.

2. The infrared imaging lens as claimed in claim 1, wherein a total track length of the infrared imaging lens ranges from 18 to 20 mm.

3. The infrared imaging lens as claimed in claim 1, wherein the infrared imaging lens further satisfies a condition of 0.14≤EFL/LT<0.2.

4. The infrared imaging lens as claimed in claim 1, wherein, under conditions where a diagonal field of view is 90 degrees and a relative illumination is greater than 90%, in case a light beam including a specific wavelength band of infrared light passes through the infrared imaging lens, a distance between a focal plane of visible light and a focal plane of infrared light on the optical axis of the infrared imaging lens exceeds 5 μm.

5. The infrared imaging lens as claimed in claim 4, wherein, within the specific wavelength band of infrared light, the infrared imaging lens is capable of achieving a modulation transfer function (MTF) of over 50% at a spatial frequency of 60 lp/mm, and the specific wavelength band of infrared light is near-infrared light ranging from 920 to 960 nm.

6. The infrared imaging lens as claimed in claim 1, wherein the infrared imaging lens satisfies a condition of 0.4≤D1/LT<0.8, where D1 is an outside diameter of the first lens, and the first lens is closest to the object side as compared with any other lens in the infrared imaging lens.

7. The infrared imaging lens as claimed in claim 1, wherein the infrared imaging lens satisfies a condition of 0.3≤DL/LT<0.6, where DL is an outside diameter of the fourth lens, and the fourth lens is closest to the image side as compared with any other lens in the infrared imaging lens.

8. The infrared imaging lens as claimed in claim 1, wherein the infrared imaging lens further includes an optical filter disposed on one side of the fourth lens away from the object side, and the optical filter blocks light outside a wavelength band of 920-960 nm.

9. The infrared imaging lens as claimed in claim 1, wherein each of the first lens, the second lens, the third lens and the fourth lens is a glass lens.

10. The infrared imaging lens as claimed in claim 1, wherein the second lens and the fourth lens are glass-molded aspheric lenses.

11. An infrared imaging lens, comprising:
a first lens, a second lens, a third lens and a fourth lens with refractive powers arranged in order from an object side to an image side of the infrared imaging lens, and a total number of lenses with refractive powers of the infrared imaging lens being at most seven; and
an aperture stop disposed between the first lens and the fourth lens,
wherein the infrared imaging lens satisfies the conditions of DFOV≥100°, 0.13≤IMH/LT≤0.18 and 0.14≤EFL/LT<1.0, where DFOV is a diagonal field of view of the infrared imaging lens, IMH is a semi-diagonal image height of the infrared imaging lens, EFL is an effective focal length of the infrared imaging lens, and LT is a distance measured along an optical axis between two outermost lens surfaces with refractive powers at opposite ends of the infrared imaging lens.

12. The infrared imaging lens as claimed in claim 11, wherein a total track length of the infrared imaging lens ranges from 18 to 20 mm.

13. The infrared imaging lens as claimed in claim 11, wherein the infrared imaging lens further satisfies a condition of 0.14≤EFL/LT<0.2.

14. The infrared imaging lens as claimed in claim 11, wherein, under conditions where a diagonal field of view is 90 degrees and a relative illumination is greater than 90%, in case a light beam including a specific wavelength band of infrared light passes through the infrared imaging lens, a distance between a focal plane of visible light and a focal plane of infrared light on the optical axis of the infrared imaging lens exceeds 5 μm.

15. The infrared imaging lens as claimed in claim 14, wherein, within the specific wavelength band of infrared light, the infrared imaging lens is capable of achieving a modulation transfer function (MTF) of over 50% at a spatial frequency of 60 lp/mm, and the specific wavelength band of infrared light is near-infrared light ranging from 920 to 960 nm.

16. The infrared imaging lens as claimed in claim 11, wherein the infrared imaging lens satisfies a condition of 0.4≤D1/LT<0.8, where D1 is an outside diameter of the first lens, and the first lens is closest to the object side as compared with any other lens in the infrared imaging lens.

17. The infrared imaging lens as claimed in claim 11, wherein the infrared imaging lens satisfies a condition of 0.3≤DL/LT<0.6, where DL is an outside diameter of the fourth lens, and the fourth lens is closest to the image side as compared with any other lens in the infrared imaging lens.

18. The infrared imaging lens as claimed in claim 11, wherein the infrared imaging lens further includes an optical filter disposed on one side of the fourth lens away from the object side, and the optical filter blocks light outside a wavelength band of 920-960 nm.

19. The infrared imaging lens as claimed in claim 11, wherein each of the first lens, the second lens, the third lens and the fourth lens is a glass lens.

20. The infrared imaging lens as claimed in claim 11, wherein the second lens and the fourth lens are glass-molded aspheric lenses.
